(19) United States
(12) Patent Application Publication
(10) Pub. No.: US 2025/0383696 A1
(43) Pub. Date: Dec. 18, 2025

(54) DEVICE RESET BASED ON VOLTAGE BROWNOUT

(71) Applicant: Micron Technology, Inc., Boise, ID (US)

(72) Inventors: Xiangdong Kong, Shanghai (CN); Jie Zhou, Shanghai (CN); Long Lu, Shanghai (CN); Deping He, Boise, ID (US)

(21) Appl. No.: 19/219,780

(22) Filed: May 27, 2025

Related U.S. Application Data
(60) Provisional application No. 63/659,222, filed on Jun. 12, 2024.

(51) Int. Cl. G06F 1/30; G06F 1/24

(52) U.S. Cl. CPC G06F 1/305; G06F 1/24

(57) ABSTRACT

Methods, systems, and devices for device reset based on voltage brownout are described. The described techniques provide for a memory system to evaluate a plurality of reset criteria, after experiencing a brownout event, to determine whether to reset the memory system. In some cases, the reset criteria may include determining whether a write command (e.g., a write operation associated with a write command) was ongoing during the brownout event, determining whether the brownout event triggered a hardware exception, and reading a status of the memory system to determine whether one or more status bits are asserted. If the memory system determines that all of the plurality of reset criteria are satisfied, then the memory system may continue to operate without resetting. Otherwise, if the memory system determines that at least one of the reset criteria is satisfied, then the memory system may reset.

### CROSS REFERENCE

The present Application for Patent claims priority to U.S. Patent Application No. 63/659,222 by Kong et al., entitled “DEVICE RESET BASED ON VOLTAGE BROWNOUT,” filed Jun. 12, 2024, which is assigned to the assignee hereof, and which is expressly incorporated by reference in its entirety herein.

### TECHNICAL FIELD

The following relates to one or more systems for memory, including device reset based on voltage brownout.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports device reset based on voltage brownout in accordance with examples as disclosed herein.

FIGS. 2-5 show examples of processes that support device reset based on voltage brownout in accordance with examples as disclosed herein.

FIG. 6 shows a block diagram of a memory system that supports device reset based on voltage brownout in accordance with examples as disclosed herein.

FIGS. 7 and 8 show flowcharts illustrating a method or methods that support device reset based on voltage brownout in accordance with examples as disclosed herein.

### DETAILED DESCRIPTION

A memory system may experience a brownout event (e.g., a voltage brownout event), during which a supply voltage of a memory device of the memory system may drop below a threshold level (e.g., temporarily drop below a threshold level) associated with normal operations. Operating at such a reduced voltage may impact operations of the memory system. For example, the brownout event may interrupt an ongoing write command at the memory device, which may leave the corresponding write operation incomplete and otherwise adversely affect the memory system. Additionally, or alternatively, the memory system may experience and declare a hardware exception due to the brownout event. For example, the brownout event may trigger a NAND flash controller (NFC) exception in response to experiencing the brownout event. In such instances, the memory system may restart (e.g., reboot) after experiencing a brownout event, regardless of whether a write command was interrupted, whether an NFC exception was raised, or based on other criteria. Rebooting the memory system may decrease the overall performance of the memory system. Thus, a memory system configured to evaluate one or more criterion after experiencing a brownout event and then determine whether to reset may be advantageous.

As described herein, a memory system may evaluate a plurality of reset criteria to determine whether to reset (e.g., reboot) after experiencing a brownout event. In some cases, the reset criteria may include determining whether a write command (e.g., a write operation associated with a write command) was ongoing during the brownout event, determining whether the brownout event triggered a hardware exception, and determining whether one or more status bits were asserted. If the memory system determines that all of (e.g., each of) the plurality of reset criteria are satisfied, then the memory system may continue to operate without resetting, which may improve its overall latency and performance. In other examples, if the memory system determines that at least one of the reset criteria is satisfied, then the memory system may reset to recover lost data and otherwise ensure that it is operating optimally. Such techniques may reduce the frequency of device resets of the memory system triggered due to brownout events, which may improve the system's overall performance and efficiency.

In addition to applicability in memory systems as described herein, techniques for performing a device reset based on a voltage brownout may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing the frequency at which a memory system resets a memory device due to voltage brownout, which may decrease processing or latency times, improve response times, or otherwise improve user experience, among other benefits.

Features of the disclosure are illustrated and described in the context of systems, devices, and circuits. Features of the disclosure are further illustrated and described in the context of processes and flowcharts.

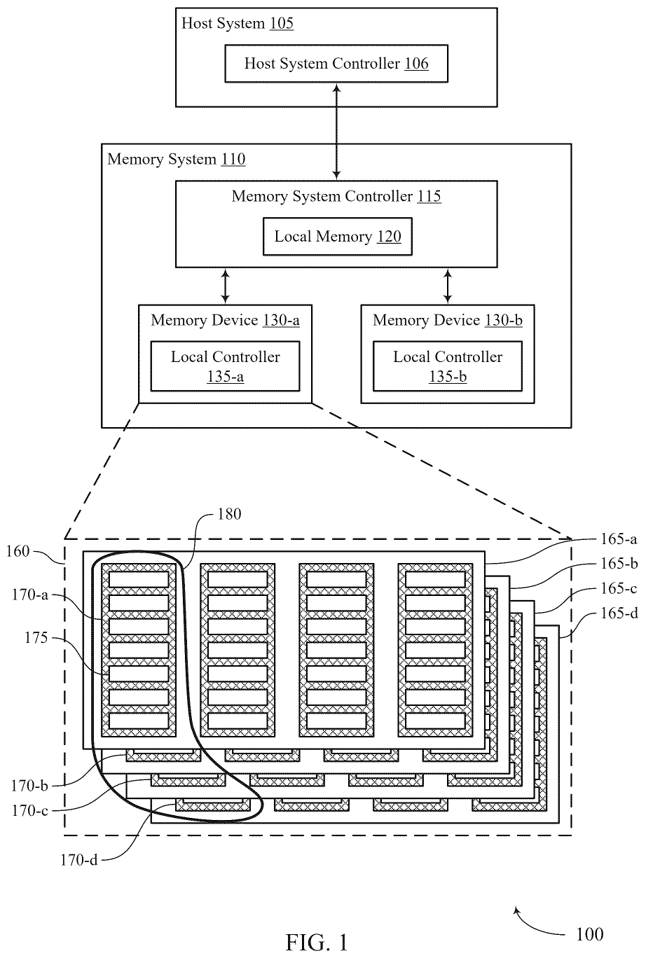

FIG. 1 shows an example of a system 100 that supports device reset based on voltage brownout in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof.

Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The system 100 may include any quantity of non-transitory computer readable media that support device reset based on voltage brownout. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the system 100 may support one or more features to reset the memory system 110 or a device of the memory system 110 (e.g., a memory device 130) after experiencing a brownout event (e.g., a voltage brownout event). During a brownout event, a voltage (e.g., a supply voltage) of the memory system 110 may drop below a threshold level associated with normal operations (e.g., for a duration), which may impact operations of the memory system 110. For example, the memory system 110 may be performing operations associated with a command (e.g., a write command) during the brownout event. The brownout event may interrupt the ongoing command, which may leave the operation (e.g., a NAND program operation) incomplete. Additionally, or alternatively, the memory system 110 may experience and declare a hardware exception due to the brownout event. For example, a controller (e.g., memory system controller 115, local controller 135) may attempt to read a status of the memory device 130 (e.g., the NAND) or may attempt a read data transfer.

Additionally, if the memory system 110 experiences a brownout event, the memory device 130 may not respond to requests from the controller or may produce an unexpected signal in response to requests from the controller. For example, the memory system 110 may use a data strobe (DQ) or a data strobe signal (DQS) as a system clock. In some cases, after a brownout event, the memory system 110 may lose the system clock and output no signal, triggering a DQS timeout exception (e.g., DQS_TO). In some other cases, after a brownout event, the memory system 110 may output a signal including additional bits of data that are not expected by the local controller 135, triggering a DQS extra exception (e.g., DQS_EXTRA).

If the memory system 110 detects a brownout event, the memory system 110 (e.g., the memory system controller 115) may declare a voltage detector (VDT) interrupt service request (ISR). The firmware of the memory system 110 may be configured to enter a safe mode in response to the VDT-ISR even if there is an ongoing command at the memory device 130. If in the safe mode, the memory system 110 may terminate ongoing firmware behavior and may initiate a device reset to begin device recovery.

To reduce the quantity of device resets due to voltage brownout, the memory system 110 may support evaluating multiple reset criteria to determine whether to reset the memory system 110 or a memory device 130 of the memory system 110 after a brownout event. In some cases, the reset criteria may include determining a write command was ongoing during the brownout event, determining whether the brownout event triggered a hardware exception (e.g., an NFC exception), and reading a status (e.g., 0x71 status) of the logical unit numbers (LUNs) of the memory system 110 to determine whether one or more status bits (e.g., a SR[4] status register) are asserted.

If the memory system 110 determines that all of the reset criteria are satisfied, then the memory system 110 may continue to operate, or continue to operate the memory device 130 without resetting. Otherwise, if the memory system 110 determines that at least one of the reset criteria is satisfied, then the memory system 110 may reset, or may reset the memory device 130. Such techniques may reduce the frequency of device resets of the memory system 110 triggered due to brownout events, which may improve device performance and efficiency.

The system 100 may include any quantity of non-transitory computer readable media that support device reset based on voltage brownout. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

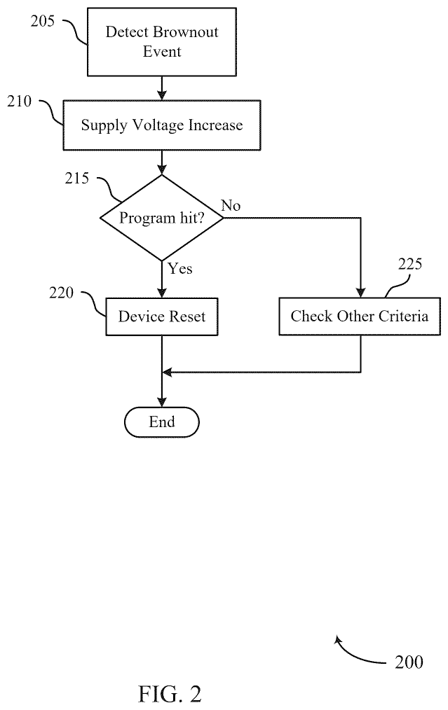

FIG. 2 shows an example of a process 200 that supports device reset based on voltage brownout in accordance with examples as disclosed herein. The process 200 may implement, or be implemented by, one or more aspects of the system 100. For example, the process 200 may illustrate operations performed by a memory system, which may be an example of a memory system 110 described with reference to FIG. 1. In some examples, the process 200 may support the memory system determining whether a plurality of device reset criteria are satisfied. Alternative examples may be implemented, where some processes are performed in a different order than described or are not performed. In some cases, processes may include additional features not mentioned below, or further processes may be added.

Aspects of the process 200 may be implemented by one or more controllers, among other components. Additionally, or alternatively, aspects of the process 200 may be implemented as instructions stored in one or more memories (e.g., firmware stored in one or more memories coupled with the memory system). For example, the instructions, if executed by one or more controllers (e.g., the memory system controller 115, the local controller 135 as described with reference to FIG. 1), may cause the one or more controllers (or a device or system) to perform the operations of the process 200.

At 205, a brownout event may be detected. For example, a memory system (e.g., memory system 110 or a memory system controller 115) may detect the brownout event. The brownout event may be, for example, a drop in a supply voltage of a memory device, such as a memory device 130 as described with reference to FIG. 1, for a duration of time. That is, a brownout event may occur if the supply voltage of the memory device 130 (or the memory system 110) drops below a threshold voltage for a duration of time. A brownout event may differ from a blackout event (e.g., a complete power loss). In some cases, a VDT component of the memory system may detect the brownout event. The memory system may declare a VDT exception in response to detecting the brownout event. For example, brownout event may trigger the memory system 110 to declare a VDT interrupt service request (ISR).

At 210, the supply voltage may increase. For example, the memory system 110 may wait for the supply voltage to return to a normal level (e.g., a level able to maintain and run the memory system 110 in a powered state). The normal level may be associated with (e.g., at or above) a voltage before the brownout event occurred. In some cases, the VDT component of the memory system 110 may determine that the supply voltage has increased to the normal level, and thus the brownout event is finished.

At 215, it may be determined whether there was a program hit during the brownout event. In some examples, the memory system controller 115 may determine whether there was a program hit during the brownout event. For example, the memory system controller 115 may determine whether an ongoing write command was occurring while the brownout event was occurring. The write command may be, for example, a write command (e.g., a program command) being executed by a memory device 130 (e.g., NAND) of the memory system. A controller of the memory system (e.g., a memory system controller 115) may send the write command to the memory device 130. To execute the write command, the memory device 130 may operate according to a higher supply voltage relative to an idle state, both of which may be higher than the supply voltage during the brownout event. The memory device 130 may be unable to complete the write command, if the brownout event (e.g., due to the voltage drop) overlaps with the write command. The memory system controller 115 may send (e.g., transmit) a request to the memory device 130 to recall all commands sent to the memory device 130 by the memory system controller 115 and may check for the presence of a write command. The memory system 110 may determine whether there is a program hit in response to the presence of a write command at the memory device 130.

At 220, if there is a program hit, a device reset may occur. For example, a back-end central processing unit (CPU) of the memory device 130 may send a request to reset the memory device 130 to a front end CPU. The front-end CPU may initiate a reset of the memory system 110 or the memory device 130. In some examples, a data flush may occur as part of the device reset process. For example, the memory system 110 may flush (e.g., send, transfer) data stored in the local memory 120 (e.g., SRAM) of the memory system 110 to the memory device 130 after detecting a brownout event. After resetting the memory device 130, the memory system 110 may restore (e.g., send, transfer) the data from the memory device 130 to the local memory 120 to restore the memory device 130 to a state before the brownout event.

At 225, if there is no program hit, other criteria may be checked. In some examples, the memory system 110 may check one or more other reset criteria to determine whether to reset the memory device 130. For example, the memory system 110 may check (e.g., determine) whether a hardware exception was triggered during the brownout event. Additionally, or alternatively, the memory system 110 may check (e.g., determine) whether one or more status bits of the memory device 130 are asserted.

Such techniques may reduce the frequency of device resets of the memory system 110 triggered due to brownout events, which may improve the overall performance of the memory system 110. That is, by performing the operations of the process 200, the memory system 110 may more selectively perform device resets based on determining whether a process (e.g., write operation) was interrupted due to a brownout event, which may support more frequent uptime and improved efficiency of the memory system 110.

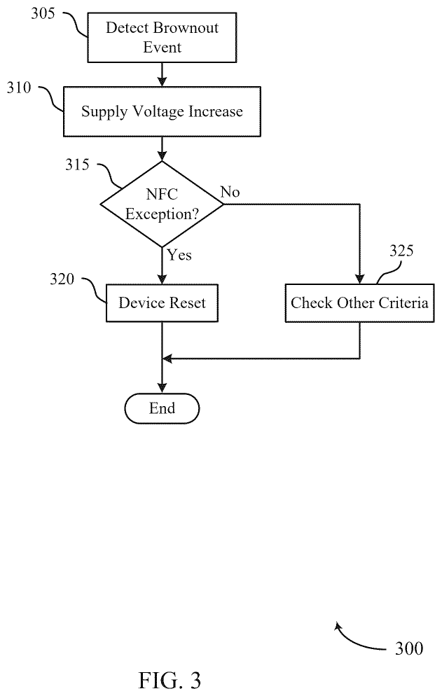

FIG. 3 shows an example of a process 300 that supports device reset based on voltage brownout in accordance with examples as disclosed herein. The process 300 may implement, or be implemented by, one or more aspects of the system 100 and the process 200. For example, the process 300 may illustrate operations performed by a memory system, which may be an example of a memory system 110 described with reference to FIG. 1. In some examples, the process 300 may support the memory system determining whether a plurality of device reset criteria are satisfied. Alternative examples may be implemented, where some processes are performed in a different order than described or are not performed. In some cases, processes may include additional features not mentioned below, or further processes may be added.

Aspects of the process 300 may be implemented by one or more controllers, among other components. Additionally, or alternatively, aspects of the process 300 may be implemented as instructions stored in one or more memories (e.g., firmware stored in one or more memories coupled with the memory system). For example, the instructions, if executed by one or more controllers (e.g., the memory system controller 115, the local controller 135 as described with reference to FIG. 1), may cause the one or more controllers (or a device or system) to perform the operations of the process 300.

At 305, a brownout event may be detected. For example, a memory system (e.g., memory system 110 or a memory system controller 115) may detect the brownout event. The brownout event may be, for example, a drop in a supply voltage of a memory device, such as a memory device 130 as described with reference to FIG. 1, for a duration of time. That is, a brownout event may occur if the supply voltage of the memory device 130 (or the memory system 110) drops below a threshold voltage for a duration of time. A brownout event may differ from a blackout event (e.g., a complete power loss). In some cases, a VDT component of the memory system may detect the brownout event. The memory system may declare a VDT exception in response to detecting the brownout event. For example, brownout event may trigger the memory system 110 to declare a VDT interrupt service request (ISR).

At 310, the supply voltage may increase. For example, the memory system 110 may wait for the supply voltage to return to a normal level (e.g., a level able to maintain and run the memory system 110 in a powered state). The normal level may be associated with (e.g., at or above) a voltage before the brownout event. In some cases, the VDT component of the memory system 110 may determine that the supply voltage has increased to the normal level.

At 315, it may be determined whether there was a hardware exception triggered during the brownout event. For example, the memory system controller 115 may determine whether a hardware exception was triggered during the brownout event. The hardware exception may be an NFC exception (e.g., DQS_TO, DQS_EXTRA) as described herein. In some examples, the brownout event may trigger a NAND reset (e.g., NAND PERESET).

A controller (e.g., memory system controller 115, local controller 135) of the memory system 110 may attempt to read a status of the memory device 130 (e.g., NAND) or may attempt a read data transfer. The memory device 130 may not respond to requests from the controller or may produce an unexpected signal in response to requests from the controller. For example, the memory system 110 may use a DQ or a DQS as a system clock. In some cases, after a brownout event the memory system 110 may lose the system clock and output no signal, triggering a DQS timeout exception (e.g., DQS_TO). In some other cases, after a brownout event the memory system 110 may output a signal including additional bits of data that are not expected by the controller, triggering a DQS extra exception (e.g., DQS_EXTRA).

At 320, if the hardware exception is triggered, a device reset may occur. For example, a back-end CPU of the memory device 130 may send a request to reset the memory device 130 to a front end CPU. The front-end CPU may initiate a reset of the memory system 110 or the memory device 130. In some examples, a data flush may occur as part of the device reset process. For example, the memory system 110 may flush (e.g., send, transfer) data stored in the local memory 120 (e.g., SRAM) of the memory system 110 to the memory device 130 after detecting a brownout event. After resetting the memory device 130, the memory system 110 may restore (e.g., send, transfer) the data from the memory device 130 to the local memory 120 to restore the memory device 130 to a state before the brownout event.

At 325, if the hardware exception is not triggered, other criteria may be checked. In some examples, the memory system 220 may check one or more other reset criteria to determine whether to reset the memory device 130. For example, the memory system 110 may check (e.g., determine) whether one or more status bits of the memory device 130 are asserted.

Such techniques may reduce the frequency of device resets of the memory system 110 triggered due to brownout events, which may improve the overall performance of the memory system 110. That is, by performing the operations of the process 300, the memory system 110 may more selectively perform device resets based on determining whether a hardware exception was declared in response to a brownout event, which may support more frequent uptime and improved efficiency of the memory system 110.

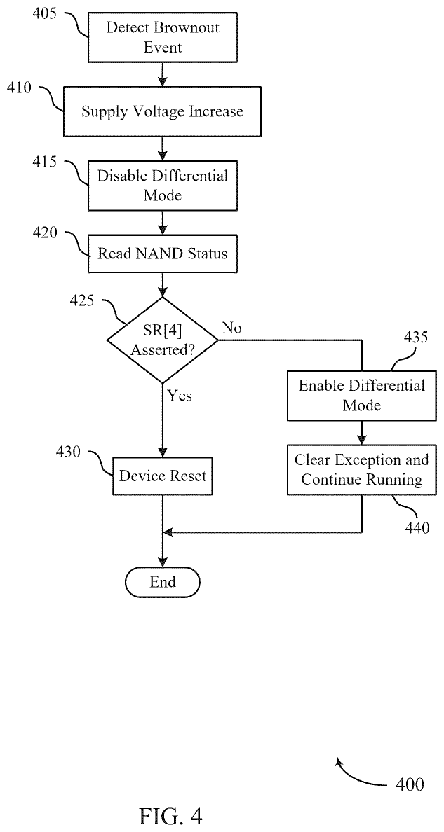

FIG. 4 shows an example of a process 400 that supports device reset based on voltage brownout in accordance with examples as disclosed herein. The process 400 may implement, or be implemented by, one or more aspects of the system 100, the process 200, and the process 300. For example, the process 400 may illustrate operations performed by a memory system, which may be an example of a memory system 110 described with reference to FIG. 1. In some examples, the process 400 may support the memory system determining whether a plurality of device reset criteria are satisfied. Alternative examples may be implemented, where some processes are performed in a different order than described or are not performed. In some cases, processes may include additional features not mentioned below, or further processes may be added.

Aspects of the process 400 may be implemented by one or more controllers, among other components. Additionally, or alternatively, aspects of the process 400 may be implemented as instructions stored in one or more memories (e.g., firmware stored in one or more memories coupled with the memory system). For example, the instructions, if executed by one or more controllers (e.g., the memory system controller 115, the local controller 135 as described with reference to FIG. 1), may cause the one or more controllers (or a device or system) to perform the operations of the process 400.

At 405, a brownout event may be detected. For example, a memory system (e.g., memory system 110 or a memory system controller 115) may detect the brownout event. The brownout event may be, for example, a drop in a supply voltage of a memory device, such as a memory device 130 as described with reference to FIG. 1, for a duration of time. That is, a brownout event may occur if the supply voltage of the memory device 130 (or the memory system 110) drops below a threshold voltage for a duration of time. A brownout event may differ from a blackout event (e.g., a complete power loss). In some cases, a VDT component of the memory system may detect the brownout event. The memory system may declare a VDT exception in response to detecting the brownout event. For example, brownout event may trigger the memory system 110 to declare a VDT interrupt service request (ISR).

At 410, the supply voltage may increase. For example, the memory system may wait for the supply voltage to return to a normal level (e.g., a level able to maintain and run the memory system 110 in a powered state). The normal level may be associated with (e.g., at or above) a voltage before the brownout event. In some cases, the VDT component of the memory system 110 may determine that the supply voltage has increased to the normal level.

At 415, a differential mode may be disabled. For example, a controller (e.g., memory system controller 115, local controller 135) of the memory system 110 may disable the differential mode of the memory system 110 and may operate in a single-ended mode. In a single-ended mode, the memory system 110 may communicate single-ended signaling with a memory device (e.g., the memory device 130) instead of differential signaling. For example, DQ signaling may be differential. In some cases (e.g., after a brownout event), there may be a DQ exception in response to the brownout event, as described herein with reference to FIG. 3. In such cases, the controller may disable the differential mode to read a status of the memory device 130 (e.g., NAND).

At 420, a status may be read. In some examples, the controller may read a status (e.g., 0x71 status) of the memory device 130. For example, the controller may read one or more status bits of a memory die (e.g., die 160) of the memory device 130.

At 425, it may be determined whether one or more status bits of the memory device 130 are asserted. In some examples, the memory system controller 115 may determine whether the one or more status bits of the memory die are asserted. For example, the memory system controller 115 may read all logical units of the memory device 130 to determine whether a status bit (e.g., SR[4] bit) is asserted for each logical unit number (LUN). The SR[4] bit may indicate a reset (e.g., PERESET) status of the memory device 130. In some examples, the value of the SR[4] bit may be changed (e.g., set) after a device reset (e.g., NAND power cycle). For example, the SR[4] bit may be set to a default value (e.g., bit value of 1) after a power cycle. The memory system 110 may determine whether at least one SR[4] bit for any LUN is asserted.

At 430, if the one or more status bits of the memory device 130 are asserted, a device reset may occur. For example, a back-end CPU of the memory device 130 may send a request to reset the memory device 130 to a front end CPU. The front-end CPU may initiate a reset of the memory system 110 or memory device 130. In some examples, a data flush may occur as part of the device reset process. For example, the memory system 110 may flush (e.g., send, transfer) data stored in the local memory 120 (e.g., SRAM) of the memory system 110 to the memory device 130 after detecting a brownout event. After resetting the memory device 130, the memory system 110 may restore (e.g., send, transfer) the data from the memory device 130 to the local memory 120 to restore the memory device 130 to a state before the brownout event.

At 435, if the one or more status bits of the memory device 130 are not asserted, a differential mode may be enabled. For example, the controller may enable the differential mode of the memory system 110.

At 440, the VDT ISR may be cleared. In some examples, the memory system 110 may clear the VDT ISR and continue running without performing a device reset. For example, the memory system 110 may perform (e.g., serve) additional operations (e.g., read operations, write operations) after clearing the VDT ISR.

Such techniques may reduce the frequency of device resets of the memory system triggered due to brownout events, which may improve the system's overall performance. That is, by performing the operations of the process 400, the memory system may more selectively perform device resets based on determining a status of the memory system in response to a brownout event, which may support more frequent uptime and improved efficiency of the memory system.

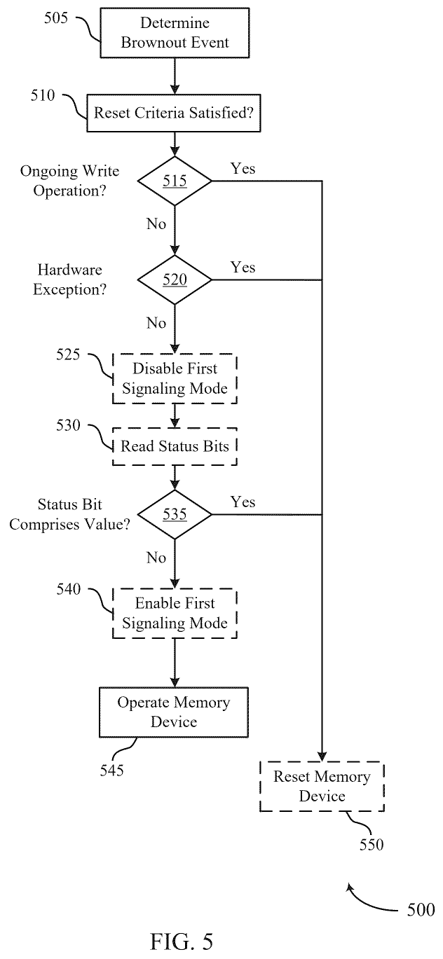

FIG. 5 shows an example of a process 500 that supports device reset based on voltage brownout in accordance with examples as disclosed herein. The process 500 may implement, or be implemented by, one or more aspects of the system 100 and the processes 200, 300, and 400. In some examples, the process 500 may illustrate operations performed by a memory system, which may be an example of a memory system 110 described with reference to FIG. 1. For example, the process 500 may support the memory system determining whether one or more reset criteria is satisfied to determine whether or not to reset a memory device of the memory system in accordance with operations and techniques described with reference to FIGS. 2 through 4. Alternative examples of the following may be implemented, where some steps are performed in a different order or not at all. Additionally, some steps may include additional features not mentioned below.

At 505, a brownout event may be detected. In some examples, the memory system may detect the brownout event. For example, the memory system may determine that a supply voltage of a memory device is below a first threshold voltage and above a second threshold voltage for a duration. The memory system may determine that the memory device experienced the brownout event.

At 510, it may be determined whether one or more reset criteria are satisfied. In some examples, the memory system may determine whether a plurality of reset criteria are satisfied after determining that the supply voltage of the memory device is below the first threshold voltage and above the second threshold voltage for the duration. The plurality of reset criteria may include determining whether a write operation was ongoing if the supply voltage of the memory device failed to satisfy the first threshold voltage, determining whether a hardware exception occurred if the supply voltage of the memory device failed to satisfy the first threshold voltage, and determining whether one or more status bits associated with a memory die of the memory device comprise a first value.

For example, at 515, it may be determined whether there was an ongoing write operation during the brownout event. In some examples, the memory system may determine whether the write operation was ongoing if the supply voltage of the memory device failed to satisfy the first threshold voltage. The memory system may determine whether there was an ongoing write operation during the brownout event in accordance with operations and techniques described with reference to FIG. 2.

At 520, if there was no ongoing write operation, it may be determined whether there was a hardware exception triggered during the brownout event. In some examples, the memory system may determine whether the hardware exception occurred if the supply voltage of the memory device failed to satisfy the first threshold voltage. In some cases, the hardware exception may include a DQ or a DQS exception (e.g., a DQS_TO exception, a DQS_EXTRA exception). The memory system may determine whether there was a hardware exception was triggered during the brownout event in accordance with operations and techniques described with reference to FIG. 3.

At 525, if the hardware exception is not triggered, a differential mode may be disabled. In some examples, the memory system may disable a first signaling mode associated with the memory device. The first signaling mode may be the differential mode.

At 530, one or more status bits may be read. For example, the memory system may read the one or more status bits from a register associated with the memory device. In some examples, the one or more status bits may be SR[4] bits from each LUN of the memory device. The memory system may read the one or more status bits in accordance with operations and techniques described with reference to FIG. 4.

At 535, it may be determined whether one or more status bits are asserted. For example, the memory system may determine whether one or more status bits associated with a memory die of the memory device (e.g., of the NAND) include a first value. In such examples, the one or more status bits associated with the memory device may include the first value in response to the memory device power cycling if the supply voltage of the memory device failed to satisfy the first threshold voltage. For example, the memory system may set a value of the one or more status bits to the first value in response to performing a power cycle of the memory device. The memory system may determine whether the one or more status bits are asserted in accordance with operations and techniques described with reference to FIG. 4.

At 540, if the one or more status bits are not asserted, the differential mode may be enabled. In some examples, the memory system may reenable the first signaling mode associated with the memory device in response to determining that the one or more status bits are not asserted. For example, the memory system may reenable the first signaling mode in response to determining that each of the status bits associated with the memory die of the memory device do not comprise the first value.

At 545, the memory device may be operated. In some examples, the memory system may operate the memory device in response to determining that the plurality of reset criteria are satisfied. For example, the memory system may determine that the plurality of reset criteria are satisfied in response to determining that the write operation was not ongoing if the supply voltage of the memory device failed to satisfy the first threshold voltage, determining that the hardware exception did not occur if the supply voltage of the memory device failed to satisfy the first threshold voltage, and determining that each of the status bits associated with the memory die of the memory device do not comprise the first value. The memory system may refrain from resetting the memory device in response to determining that the plurality of reset criteria are satisfied.

At 550, if any of the plurality of reset criteria are not satisfied, the memory device may be reset. In some examples, the memory system may reset the memory device in response to determining that at least one of the plurality of reset criteria are not satisfied. For example, the memory system may reset the memory device in response to determining that the write operation was ongoing if the supply voltage of the memory device failed to satisfy the first threshold voltage. Additionally, or alternatively, the memory system may reset the memory device in response to determining that the hardware exception occurred if the supply voltage of the memory device failed to satisfy the first threshold voltage. Additionally, or alternatively, the memory system may reset the memory device in response to determining that one or more of the status bits associated with the memory die comprise the first value.

In some examples, a data flush may occur as part of the device reset process. For example, the memory system may flush (e.g., send, transfer) data stored in a local memory of the memory system (e.g., SRAM) to the NAND after detecting a brownout event. After resetting the device, the memory system may restore (e.g., send, transfer) the data from the NAND to the SRAM to restore the device to a state before the brownout event.

Such techniques may support the memory system evaluating a plurality of reset criteria after experiencing a brownout event to reduce a frequency of device resets, thereby reducing latency and improving device performance.

Aspects of the process 500 may be implemented by one or more controllers, among other components. Additionally, or alternatively, aspects of the process 500 may be implemented as instructions stored in one or more memories (e.g., firmware stored in one or more memories coupled with the memory system). For example, the instructions, if executed by one or more controllers (e.g., the memory system controller 115, the local controller 135 as described with reference to FIG. 1), may cause the one or more controllers (or a device or system) to perform the operations of the process 500.

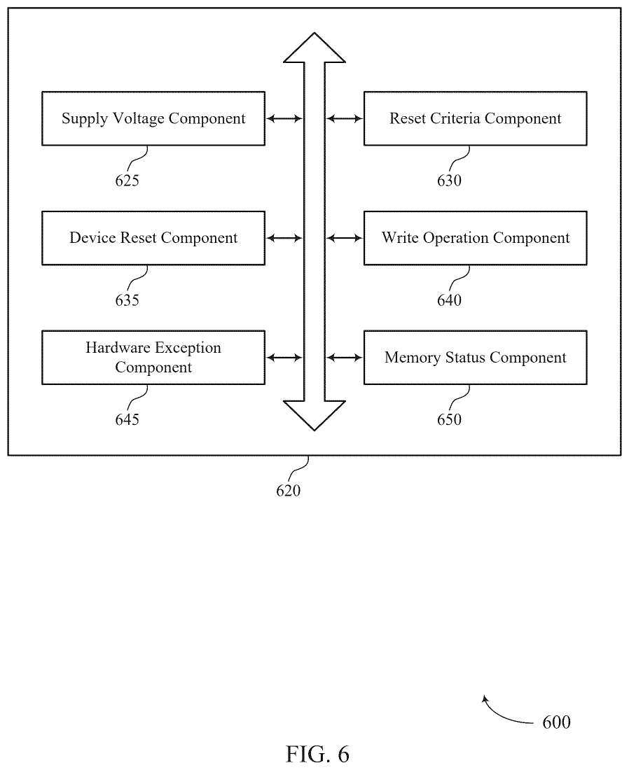

FIG. 6 shows a block diagram 600 of a memory system 620 that supports device reset based on voltage brownout in accordance with examples as disclosed herein. The memory system 620 may be an example of aspects of a memory system as described with reference to FIGS. 1 through 5. The memory system 620, or various components thereof, may be an example of means for performing various aspects of device reset based on voltage brownout as described herein. For example, the memory system 620 may include a supply voltage component 625, a reset criteria component 630, a device reset component 635, a write operation component 640, a hardware exception component 645, a memory status component 650, or any combination thereof. Each of these components, or components of subcomponents thereof (e.g., one or more processors, one or more memories), may communicate, directly or indirectly, with one another (e.g., via one or more buses).

The supply voltage component 625 may be configured as or otherwise support a means for determining whether a plurality of reset criteria are satisfied in accordance with a supply voltage of the memory device being below a first threshold voltage and above a second threshold voltage for a duration. The reset criteria component 630 may be configured as or otherwise support a means for operating the memory device in response to determining that the plurality of reset criteria are satisfied.

In some examples, the device reset component 635 may be configured as or otherwise support a means for resetting the memory device in response to determining that at least one of the plurality of reset criteria are not satisfied.

In some examples, to support determining whether the plurality of reset criteria are satisfied, the reset criteria component 630 may be configured as or otherwise support a means for determining whether a write operation was ongoing if the supply voltage of the memory device failed to satisfy the first threshold voltage, where resetting the memory device is in response to determining that the write operation was ongoing if the supply voltage of the memory device failed to satisfy the first threshold voltage.

In some examples, to support determining whether the plurality of reset criteria are satisfied, the reset criteria component 630 may be configured as or otherwise support a means for determining whether a hardware exception occurred if the supply voltage of the memory device failed to satisfy the first threshold voltage, where resetting the memory device is in response to determining that the hardware exception occurred if the supply voltage of the memory device failed to satisfy the first threshold voltage.

In some examples, the hardware exception includes a data strobe or a data strobe signal exception.

In some examples, to support determining whether the plurality of reset criteria are satisfied, the reset criteria component 630 may be configured as or otherwise support a means for determining whether one or more status bits associated with a memory die of the memory device include a first value, where resetting the memory device is in response to determining that one or more of the status bits associated with the memory die include the first value.

In some examples, the one or more status bits associated with the memory device include the first value in accordance with the memory device power cycling if the supply voltage of the memory device failed to satisfy the first threshold voltage.

In some examples, to support plurality of reset criteria, the write operation component 640 may be configured as or otherwise support a means for determining whether a write operation was ongoing if the supply voltage of the memory device failed to satisfy the first threshold voltage. In some examples, to support plurality of reset criteria, the hardware exception component 645 may be configured as or otherwise support a means for determining whether a hardware exception occurred if the supply voltage of the memory device failed to satisfy the first threshold voltage. In some examples, to support plurality of reset criteria, the memory status component 650 may be configured as or otherwise support a means for determining whether one or more status bits associated with a memory die of the memory device include a first value.

In some examples, to support operating the memory device, the write operation component 640 may be configured as or otherwise support a means for determining that the write operation was not ongoing if the supply voltage of the memory device failed to satisfy the first threshold voltage. In some examples, to support operating the memory device, the hardware exception component 645 may be configured as or otherwise support a means for determining that the hardware exception did not occur if the supply voltage of the memory device failed to satisfy the first threshold voltage. In some examples, to support operating the memory device, the memory status component 650 may be configured as or otherwise support a means for determining that each of the status bits associated with the memory die of the memory device do not include the first value.

In some examples, to support determining whether the one or more status bits associated with the memory device include the first value, the memory status component 650 may be configured as or otherwise support a means for disabling a first signaling mode associated with the memory device. In some examples, to support determining whether the one or more status bits associated with the memory device include the first value, the memory status component 650 may be configured as or otherwise support a means for reading the one or more status bits from a register associated with the memory device, where the first signaling mode is reenabled in response to determining that each of the status bits associated with the memory die of the memory device do not include the first value.

In some examples, to support operating the memory device, the reset criteria component 630 may be configured as or otherwise support a means for refraining from resetting the memory device in response to determining that the plurality of reset criteria are satisfied.

In some examples, to support determining that the supply voltage of the memory device is below the first threshold voltage and above the second threshold voltage, the supply voltage component 625 may be configured as or otherwise support a means for determining that the memory device experienced a brownout event.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

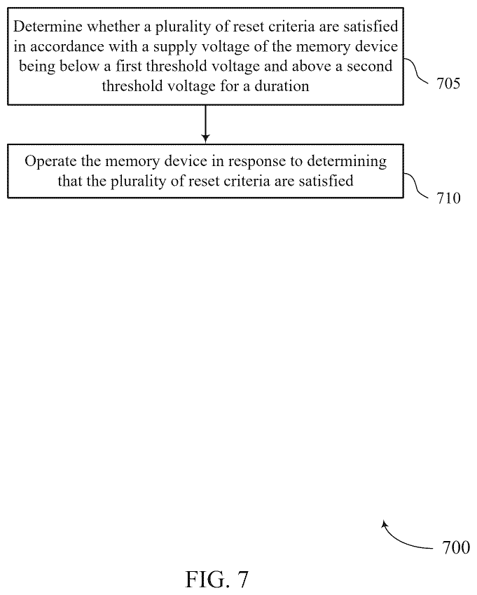

FIG. 7 shows a flowchart illustrating a method 700 that supports device reset based on voltage brownout in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include determining whether a plurality of reset criteria are satisfied in accordance with a supply voltage of the memory device being below a first threshold voltage and above a second threshold voltage for a duration. In some examples, aspects of the operations of 705 may be performed by a supply voltage component 625 as described with reference to FIG. 6.

At 710, the method may include operating the memory device in response to determining that the plurality of reset criteria are satisfied. In some examples, aspects of the operations of 710 may be performed by a reset criteria component 630 as described with reference to FIG. 6.

In some examples, an apparatus as described herein may perform a method or methods, such as the method 700. The apparatus may include operations, features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for determining whether a plurality of reset criteria are satisfied in accordance with a supply voltage of the memory device being below a first threshold voltage and above a second threshold voltage for a duration and operating the memory device in response to determining that the plurality of reset criteria are satisfied.

Aspect 2: The method, apparatus, or non-transitory computer-readable medium of aspect 1, further including operations, features, circuitry, logic, means, or instructions, or any combination thereof for resetting the memory device in response to determining that at least one of the plurality of reset criteria are not satisfied.

Aspect 3: The method, apparatus, or non-transitory computer-readable medium of aspect 2, where determining whether the plurality of reset criteria are satisfied includes operations, features, circuitry, logic, means, or instructions, or any combination thereof for determining whether a write operation was ongoing if the supply voltage of the memory device failed to satisfy the first threshold voltage, where resetting the memory device is in response to determining that the write operation was ongoing if the supply voltage of the memory device failed to satisfy the first threshold voltage.

Aspect 4: The method, apparatus, or non-transitory computer-readable medium of any of aspects 2 through 3, where determining whether the plurality of reset criteria are satisfied includes operations, features, circuitry, logic, means, or instructions, or any combination thereof for determining whether a hardware exception occurred if the supply voltage of the memory device failed to satisfy the first threshold voltage, where resetting the memory device is in response to determining that the hardware exception occurred if the supply voltage of the memory device failed to satisfy the first threshold voltage.

Aspect 5: The method, apparatus, or non-transitory computer-readable medium of aspect 4, where the hardware exception includes a data strobe or a data strobe signal exception.

Aspect 6: The method, apparatus, or non-transitory computer-readable medium of any of aspects 2 through 5, where determining whether the plurality of reset criteria are satisfied includes operations, features, circuitry, logic, means, or instructions, or any combination thereof for determining whether one or more status bits associated with a memory die of the memory device include a first value, where resetting the memory device is in response to determining that one or more of the status bits associated with the memory die include the first value.

Aspect 7: The method, apparatus, or non-transitory computer-readable medium of aspect 6, where the one or more status bits associated with the memory device include the first value in accordance with the memory device power cycling if the supply voltage of the memory device failed to satisfy the first threshold voltage.

Aspect 8: The method, apparatus, or non-transitory computer-readable medium of any of aspects 1 through 7, where the plurality of reset criteria includes operations, features, circuitry, logic, means, or instructions, or any combination thereof for determining whether a write operation was ongoing if the supply voltage of the memory device failed to satisfy the first threshold voltage; determining whether a hardware exception occurred if the supply voltage of the memory device failed to satisfy the first threshold voltage; and determining whether one or more status bits associated with a memory die of the memory device include a first value.

Aspect 9: The method, apparatus, or non-transitory computer-readable medium of aspect 8, where operating the memory device includes operations, features, circuitry, logic, means, or instructions, or any combination thereof for determining that the write operation was not ongoing if the supply voltage of the memory device failed to satisfy the first threshold voltage; determining that the hardware exception did not occur if the supply voltage of the memory device failed to satisfy the first threshold voltage; and determining that each of the status bits associated with the memory die of the memory device do not include the first value.

Aspect 10: The method, apparatus, or non-transitory computer-readable medium of any of aspects 8 through 9, where determining whether the one or more status bits associated with the memory device include the first value includes operations, features, circuitry, logic, means, or instructions, or any combination thereof for disabling a first signaling mode associated with the memory device and reading the one or more status bits from a register associated with the memory device, where the first signaling mode is reenabled in response to determining that each of the status bits associated with the memory die of the memory device do not include the first value.

Aspect 11: The method, apparatus, or non-transitory computer-readable medium of any of aspects 1 through 10, where operating the memory device includes operations, features, circuitry, logic, means, or instructions, or any combination thereof for refraining from resetting the memory device in response to determining that the plurality of reset criteria are satisfied.

Aspect 12: The method, apparatus, or non-transitory computer-readable medium of any of aspects 1 through 11, where determining that the supply voltage of the memory device is below the first threshold voltage and above the second threshold voltage includes operations, features, circuitry, logic, means, or instructions, or any combination thereof for determining that the memory device experienced a brownout event.

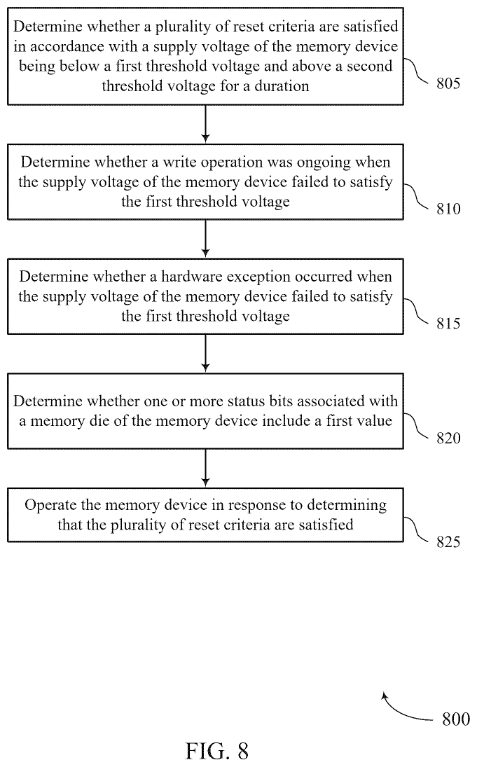

FIG. 8 shows a flowchart illustrating a method 800 that supports device reset based on voltage brownout in accordance with examples as disclosed herein. The operations of method 800 may be implemented by a memory system or its components as described herein. For example, the operations of method 800 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 805, the method may include determining whether a plurality of reset criteria are satisfied in accordance with a supply voltage of the memory device being below a first threshold voltage and above a second threshold voltage for a duration. In some examples, aspects of the operations of 805 may be performed by a supply voltage component 625 as described with reference to FIG. 6.

At 810, the method may include determining whether a write operation was ongoing if the supply voltage of the memory device failed to satisfy the first threshold voltage. In some examples, aspects of the operations of 810 may be performed by a write operation component 640 as described with reference to FIG. 6.

At 815, the method may include determining whether a hardware exception occurred if the supply voltage of the memory device failed to satisfy the first threshold voltage. In some examples, aspects of the operations of 815 may be performed by a hardware exception component 645 as described with reference to FIG. 6.

At 820, the method may include determining whether one or more status bits associated with a memory die of the memory device include a first value. In some examples, aspects of the operations of 820 may be performed by a memory status component 650 as described with reference to FIG. 6.

At 825, the method may include operating the memory device in response to determining that the plurality of reset criteria are satisfied. In some examples, aspects of the operations of 825 may be performed by a reset criteria component 630 as described with reference to FIG. 6.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in response to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
one or more memory arrays; and
processing circuitry coupled with the one or more memory arrays and configured to cause the memory device to:
determine whether a plurality of reset criteria are satisfied in accordance with a supply voltage of the memory device being below a first threshold voltage and above a second threshold voltage for a duration; and
operate the memory device in response to determining that the plurality of reset criteria are satisfied.

2. The memory device of claim 1, wherein the processing circuitry is further configured to cause the memory device to:
reset the memory device in response to determining that at least one of the plurality of reset criteria are not satisfied.

3. The memory device of claim 2, wherein determining whether the plurality of reset criteria are satisfied comprises the processing circuitry configured to cause the memory device to:
determine whether a write operation was ongoing when the supply voltage of the memory device failed to satisfy the first threshold voltage, wherein resetting the memory device is in response to determining that the write operation was ongoing when the supply voltage of the memory device failed to satisfy the first threshold voltage.

4. The memory device of claim 2, wherein determining whether the plurality of reset criteria are satisfied comprises the processing circuitry configured to cause the memory device to:
determine whether a hardware exception occurred when the supply voltage of the memory device failed to satisfy the first threshold voltage, wherein resetting the memory device is in response to determining that the hardware exception occurred when the supply voltage of the memory device failed to satisfy the first threshold voltage.

5. The memory device of claim 4, wherein the hardware exception comprises a data strobe (DQ) or a data strobe signal (DQS) exception.

6. The memory device of claim 2, wherein determining whether the plurality of reset criteria are satisfied comprises the processing circuitry configured to cause the memory device to:
determine whether one or more status bits associated with a memory die of the memory device comprise a first value, wherein resetting the memory device is in response to determining that one or more of the status bits associated with the memory die comprise the first value.

7. The memory device of claim 6, wherein the one or more status bits associated with the memory device comprise the first value in accordance with the memory device power cycling when the supply voltage of the memory device failed to satisfy the first threshold voltage.

8. The memory device of claim 1, wherein the plurality of reset criteria comprises the processing circuitry configured to cause the memory device to:
determine whether a write operation was ongoing when the supply voltage of the memory device failed to satisfy the first threshold voltage;
determine whether a hardware exception occurred when the supply voltage of the memory device failed to satisfy the first threshold voltage; and
determine whether one or more status bits associated with a memory die of the memory device comprise a first value.

9. The memory device of claim 8, wherein operating the memory device comprises the processing circuitry configured to cause the memory device to:
determine that the write operation was not ongoing when the supply voltage of the memory device failed to satisfy the first threshold voltage;
determine that the hardware exception did not occur when the supply voltage of the memory device failed to satisfy the first threshold voltage; and
determine that each of the status bits associated with the memory die of the memory device do not comprise the first value.

10. The memory device of claim 8, wherein determining whether the one or more status bits associated with the memory device comprise the first value comprises the processing circuitry configured to cause the memory device to:
disable a first signaling mode associated with the memory device; and
read the one or more status bits from a register associated with the memory device, wherein the first signaling mode is reenabled in response to determining that each of the status bits associated with the memory die of the memory device do not comprise the first value.

11. The memory device of claim 1, wherein operating the memory device comprises the processing circuitry configured to cause the memory device to:
refrain from resetting the memory device in response to determining that the plurality of reset criteria are satisfied.

12. The memory device of claim 1, wherein determining that the supply voltage of the memory device is below the first threshold voltage and above the second threshold voltage comprises the processing circuitry configured to cause the memory device to:
determine that the memory device experienced a brownout event.

13. A non-transitory computer-readable medium storing code, the code comprising instructions executable by one or more processors to:
determine whether a plurality of reset criteria are satisfied in accordance with a supply voltage of a memory device being below a first threshold voltage and above a second threshold voltage for a duration; and
operate the memory device in response to determining that the plurality of reset criteria are satisfied.

14. The non-transitory computer-readable medium of claim 13, wherein the instructions are further executable by the one or more processors to:
reset the memory device in response to determining that at least one of the plurality of reset criteria are not satisfied.

15. The non-transitory computer-readable medium of claim 14, wherein the instructions to determine whether the plurality of reset criteria are satisfied are executable by the one or more processors to:
determine whether a write operation was ongoing when the supply voltage of the memory device failed to satisfy the first threshold voltage, wherein resetting the memory device is in response to determining that the write operation was ongoing when the supply voltage of the memory device failed to satisfy the first threshold voltage.

16. The non-transitory computer-readable medium of claim 14, wherein the instructions to determine whether the plurality of reset criteria are satisfied are executable by the one or more processors to:
determine whether a hardware exception occurred when the supply voltage of the memory device failed to satisfy the first threshold voltage, wherein resetting the memory device is in response to determining that the hardware exception occurred when the supply voltage of the memory device failed to satisfy the first threshold voltage.

17. The non-transitory computer-readable medium of claim 16, wherein the hardware exception comprises a data strobe (DQ) or a data strobe signal (DQS) exception.

18. The non-transitory computer-readable medium of claim 14, wherein the instructions to determine whether the plurality of reset criteria are satisfied are executable by the one or more processors to:
determine whether one or more status bits associated with a memory die of the memory device comprise a first value, wherein resetting the memory device is in response to determining that one or more of the status bits associated with the memory die comprise the first value.

19. The non-transitory computer-readable medium of claim 18, wherein the one or more status bits associated with the memory device comprise the first value in accordance with the memory device power cycling when the supply voltage of the memory device failed to satisfy the first threshold voltage.

20. The non-transitory computer-readable medium of claim 13, wherein the instructions to determine whether the plurality of reset criteria are satisfied are executable by the one or more processors to:
determine whether a write operation was ongoing when the supply voltage of the memory device failed to satisfy the first threshold voltage;
determine whether a hardware exception occurred when the supply voltage of the memory device failed to satisfy the first threshold voltage; and
determine whether one or more status bits associated with a memory die of the memory device comprise a first value.

21. The non-transitory computer-readable medium of claim 20, wherein the instructions to operate the memory device are executable by the one or more processors to:
determine that the write operation was not ongoing when the supply voltage of the memory device failed to satisfy the first threshold voltage;
determine that the hardware exception did not occur when the supply voltage of the memory device failed to satisfy the first threshold voltage; and
determine that each of the status bits associated with the memory die of the memory device do not comprise the first value.

22. The non-transitory computer-readable medium of claim 20, wherein the instructions to determine whether the one or more status bits associated with the memory device comprise the first value are executable by the one or more processors to:
disable a first signaling mode associated with the memory device; and
read the one or more status bits from a register associated with the memory device, wherein the first signaling mode is reenabled in response to determining that each of the status bits associated with the memory die of the memory device do not comprise the first value.

23. The non-transitory computer-readable medium of claim 13, wherein the instructions to operate the memory device are executable by the one or more processors to:
refrain from resetting the memory device in response to determining that the plurality of reset criteria are satisfied.

24. The non-transitory computer-readable medium of claim 13, wherein the instructions to determine that the supply voltage of the memory device is below the first threshold voltage and above the second threshold voltage are executable by the one or more processors to:
determine that the memory device experienced a brownout event.

25. A method by a memory device, comprising:
determining whether a plurality of reset criteria are satisfied in accordance with a supply voltage of the memory device being below a first threshold voltage and above a second threshold voltage for a duration; and
operating the memory device in response to determining that the plurality of reset criteria are satisfied.
